(19) United States
(12) Patent Application Publication
(10) Pub. No.: US 2018/0243987 A1
(43) Pub. Date: Aug. 30, 2018

(54) SYSTEM AND METHOD FOR ADDITIVELY MANUFACTURING AN ARTICLE INCORPORATING MATERIALS WITH A LOW TEAR STRENGTH

(71) Applicant: Bridgestone Americas Tire Operations, LLC, Nashville, TN (US)

(72) Inventor: Adam K. Nesbitt, Akron, OH (US)

(21) Appl. No.: 15/879,493

(22) Filed: Jan. 25, 2018

Related U.S. Application Data
(60) Provisional application No. 62/450,276, filed on Jan. 25, 2017.

(51) Int. Cl. B29C 64/245; B29C 64/135; B33Y 10/00; B33Y 30/00

(52) U.S. Cl. CPC B29C 64/245; B29C 64/135; B29K 2995/0081; B33Y 30/00; B33Y 10/00

(57) ABSTRACT

An apparatus for producing three-dimensional objects includes at least one photon source configured to direct photons into a build medium. The apparatus further includes a vat configured to retain the build medium. The vat includes a window that permits photons to reach the build medium. The apparatus also has a build platform configured to translate vertically and an actuator configured to cause the build platform to move relative to the vat. The apparatus further includes a vibrator connected to the apparatus. The vibrator provides a mechanical force for moving the vat or the build platform.

### CROSS-REFERENCE TO RELATED APPLICATION

This application claims priority to U.S. Provisional Patent Application No. 62/450,276, filed on Jan. 24, 2017, the disclosure of which is incorporated by reference herein in its entirety.

### FIELD OF INVENTION

The present disclosure is directed to methods and apparatuses for making shaped objects containing materials with a low tear strength. More particularly, the present disclosure is directed to 3D printing or additive manufacturing methods and apparatuses including ultrasonic vibration during a build. The printed or manufactured object may be used in a variety of applications, including tire applications.

### BACKGROUND

Known methods and apparatuses of 3D printing, which is also referred to as additive manufacturing, utilize polymeric materials, such as polyactic acid (PLA), acrylonitrile butadiene styrene (ABS), or nylon, or metals, such as steel. Methods and apparatuses used in 3D printers vary according to the material used in the printer.

Stereolithography is a particular type of 3D printing. In stereolithographic printing, light is used to cure a thin layer of a build medium (typically a liquid), which is stored in a vat. Successive layers are cured until a complete three-dimensional object is produced. Specific methods and apparatus components are implemented to build a product.

### SUMMARY OF THE INVENTION

In one embodiment, a system for additive manufacturing includes at least one photon source that is configured to direct photons into a build medium. The system also includes a vat configured to retain the build medium. The vat includes a window that permits photons to reach the build medium. The system further has a build platform configured to translate vertically and an actuator configured to cause the build platform to move relative to the vat. The system also has an ultrasonic vibrator connected to the apparatus. The ultrasonic vibrator provides a mechanical force for moving the vat or the build platform. The system further includes a control system that coordinates actions of the vat, build platform, actuator, at least one photon source, and ultrasonic vibrator during production of an article.

In another embodiment, an apparatus for producing three-dimensional objects includes at least one photon source configured to direct photons into a build medium. The apparatus further includes a vat configured to retain the build medium. The vat includes a window that permits photons to reach the build medium. The apparatus also has a build platform configured to translate vertically and an actuator configured to cause the build platform to move relative to the vat. The apparatus further includes a vibrator connected to the apparatus. The vibrator provides a mechanical force for moving the vat or the build platform.

In yet another embodiment, a method for producing three-dimensional objects includes providing power to a printing apparatus, providing build materials to the printing apparatus, and identifying a structure to be printed by the printing apparatus. The method further includes commencing an iterative build process comprising activating and positioning a photon source, directing photons into the build medium across a two-dimensional cross-section, and deactivating the photon source. The method also includes vibrating at least one component of the printing apparatus ultrasonically.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. It should also be understood that steps in a method shown as a single step may be replaced with multiple steps, steps shown as multiple steps may be replaced with a single step, and the ordering of certain steps may be varied without altering the method. The drawings are not to scale and the proportion of certain elements may be exaggerated for the purpose of illustration.

FIG. 1 is a schematic view of one embodiment of an apparatus for 3D printing or additively manufacturing an article incorporating materials having a low tear strength;

FIG. 2 is a schematic view of an alternative embodiment of an apparatus for 3D printing or additively manufacturing an article incorporating materials having a low tear strength;

FIGS. 3A-C are schematic views of alternative embodiments of an apparatus for 3D printing or additively manufacturing an article incorporating materials having a low tear strength, and;

FIG. 4 is a flow chart detailing the steps of a method for additively printing an article incorporating materials having a low tear strength.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“3D printer” refers to a machine used for 3D printing.

“3D printing” refers to the fabrication of objects through the deposition of a material using a print head, nozzle, or another printer technology.

“3D scanning” refers to a method of acquiring the shape and size of an object as a three-dimensional representation by recording spatial coordinates on the object's surface.

“Additive manufacturing” or “AM” refers to a process of joining materials to make objects from 3D model data, usually layer upon layer, as opposed to subtractive manufacturing methodologies. Additive manufacturing includes 3D printing, binder jetting, directed energy deposition, fused deposition modeling, laser sintering, material jetting, material extrusion, powder bed fusion, rapid prototyping, rapid tooling, sheet lamination, and vat photopolymerization.

“Additive systems” refer to machines used for additive manufacturing.

“Binder jetting” refers to an additive manufacturing process in which a liquid bonding agent is selectively deposited to join powder materials.

“Computer-Aided Design” or “CAD” refers to use of computers for the design of real or virtual objects.

“Computer-Aided Manufacturing” or “CAM” typically refers to systems that use surface data to drive CNC machines, such as digitally-driven mills and lathes, to produce parts, molds, and dies.

“Computer Numerical Control” or “CNC” refers to computerized control of machines for manufacturing.

“Directed energy deposition” refers to an additive manufacturing process in which focused thermal energy is used to fuse materials by melting as they are being deposited.

“Facet” refers to a three- or four-sided polygon that represents an element of a 3D polygonal mesh surface or model.

“Focused thermal energy” refers to an energy source (e.g., laser, electron beam, or plasma arc) that is focused to melt the materials being deposited.

“Fused deposition modeling” refers to a material extrusion process used to make thermoplastic parts through heated extrusion and deposition of materials layer by layer.

“Laser sintering” or “LS” refers to a powder bed fusion process used to produce objects from powdered materials using one or more lasers to selectively fuse or melt the particles at the surface, layer by layer, in an enclosed chamber.

“Material extrusion” refers to an additive manufacturing process in which material is selectively dispensed through a nozzle or orifice.

“Material jetting” refers to an additive manufacturing process in which droplets of build material are selectively deposited. Example materials include, without limitation, photopolymer and wax.

“Powder bed fusion” refers to an additive manufacturing process in which thermal energy selectively fuses regions of a powder bed.

“Rapid prototyping” refers to additive manufacturing of a design, often iterative, for form, fit, or functional testing, or combination thereof.

“Rapid tooling” refers to the use of additive manufacturing to make tools or tooling quickly, either directly, by making parts that serve as the actual tools or tooling components, such as mold inserts, or indirectly, by producing patterns that are, in turn, used in a secondary process to produce the actual tools.

“Reverse engineering,” in the additive manufacturing context, refers to a method of creating a digital representation from a physical object to define its shape, dimensions, and internal and external features.

“Sheet lamination” refers to an additive manufacturing process in which sheets of material are bonded to form an object.

“STL” refers to a file format for 3D model data used by machines to build physical parts.

“Subtractive manufacturing” refers to making objects by removing of material (for example, buffing, milling, drilling, grinding, carving, etc.) from a bulk solid to leave a desired shape, as opposed to additive manufacturing.

“Surface model” refers to a mathematical or digital representation of an object as a set of planar or curved surfaces, or both, that may or may not represent a closed volume.

“Tool” or “Tooling” refers to a mold, die, or other device used in various manufacturing and fabricating processes such as plastic injection molding, thermoforming, blow molding, vacuum casting, die casting, sheet metal stamping, hydroforming, forging, composite lay-up tools, machining and assembly fixtures, etc.

“Vat photopolymerization” refers to an additive manufacturing process in which liquid photopolymer in a vat is selectively cured by light-activated polymerization.

While similar terms used in the following descriptions describe similar components and steps, it is understood that because the terms carry slightly different connotations, one of ordinary skill in the art would not consider any one of the following terms to be purely interchangeable with another term used to describe a similar component or step.

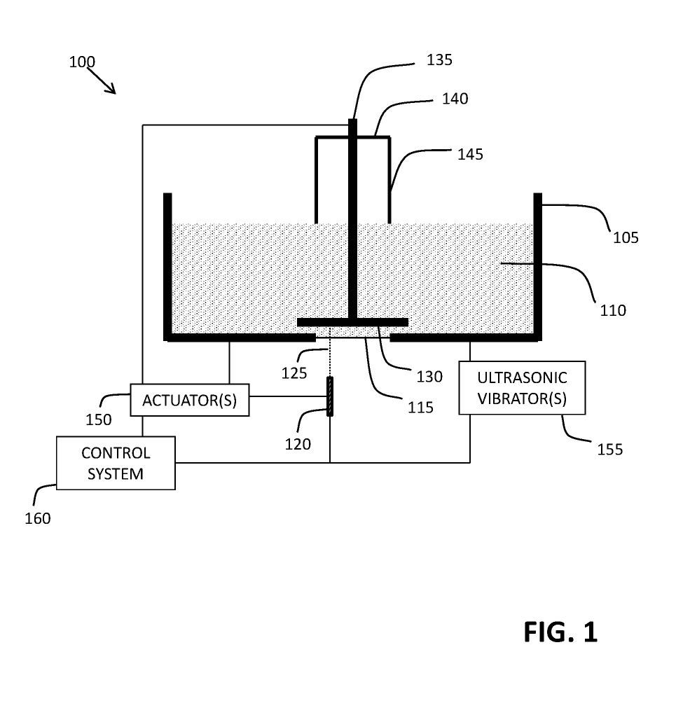

FIG. 1 is a schematic view of an apparatus 100 for 3D printing or additively manufacturing an article incorporating materials having a low tear strength. Apparatus 100 could be a 3D printer or additive system.

The term “low tear strength” is generally understood in the art. Examples of materials having low tear strength include materials having less than 250% strain at break and an average maximum stress value in the range of 0.1 to 4 MPa. More particularly, a low tear strength material may have less than 200% strain at break and an average maximum stress value in the range of 0.1 to 4 MPa. However, other examples of low tear strength material have less than 300% strain at break and an average maximum stress value in the range of 7 to 10 MPa.

As shown, the apparatus 100 includes a vat 105, which is filled with a build medium 110. As shown, vat 105 is a rectangular receptacle that holds build medium 110. Exemplary build mediums are disclosed in U.S. Provisional Patent Application No. 62/142,271 (entitled, “Actinic Radiation Curable Polymeric Mixtures, Cured Polymeric Mixtures, and Related Processes”), the disclosure of which is incorporated herein. In an alternative embodiment (not shown), a cover (awning, guard, lid, etc.) extends over at least a portion of the vat. As one of ordinary skill in the art will understand, a number of shapes may be used for the vat.

As also shown, vat 105 further includes a window 115 that allows photon source 120 to direct photons 125 to build medium 110. In particular, window 115, which is located on the underside of vat 105, is transparent so that photons 125 may reach build medium 110. In one embodiment (not shown), the window spans the entire underside of the vat. In an alternative embodiment (also not shown), the window is located on the top of the vat. As one of ordinary skill in the art will understand, the window may be a variety of cross sections and shapes.

Photon source 120 emits photons 125 (which are depicted by a thin, dashed line) that pass through window 115 and enter build medium 110. Photons 125 cure build medium 110 so that it solidifies relative to the viscous material surrounding it. The cured build medium (not shown) becomes a thin layer that forms an iterative layer of a final article.

Apparatus 100 further includes a build platform 130, a vertical support 135, and at least one actuator 150. As photons 125 cure build medium 110, the cured build medium (not shown) adheres to build platform 130 and window 115 as an iterative layer. When an iterative layer is completed, actuator 150 raises build platform 130 vertically (via vertical support 135) by a predetermined distance, and the cured build medium is separated from window 115. Viscous build medium 110 then flows into the space vacated by the cured build medium and build platform 130, and the next iterative layer is formed against the prior iterative layer and window 115. In one embodiment (not shown), the photon source is temporarily deactivated when the actuator moves the build plate vertically.

In a particular embodiment (the movement described in this paragraph is not shown), the actuator first moves one edge of the build plate so that the build plate and the iterative layer peel away from the window. The actuator then continues to move the build plate so that the entire iterative layer is separated from the window. Viscous build medium then flows into the space vacated by the cured build medium and the build platform, and the next iterative layer is formed against the prior iterative layer and the window.

In another particular embodiment (the movement described in this paragraph is not shown), the actuator preferentially moves the vat so that the iterative layer shears off the window. The actuator continues to move the build plate so that the entire iterative layer is separated from the window. Viscous build medium then flows into the space vacated by the cured build medium and build platform, and the next iterative layer is formed against the prior iterative layer and the window.

In yet another particular embodiment (not shown), a layer of gas lines the bottom of the vat so that cured build medium does not adhere to the window. When an iterative layer is completed, the actuator moves the build plate so that viscous build medium can flow into the vacated space and another iterative layer may be formed. In one embodiment, the gas is an inert gas. In an alternative embodiment, the gas is argon. In yet another alternative embodiment, the gas is nitrogen.

With continued reference to FIG. 1, actuator 150, in addition to moving build platform 130 vertically, may also move build platform 130 horizontally. Actuator 150 may also rotate build platform 130 independently from, or in conjunction with, any translation movement. Further, actuator 150 may also be connected to vat 105 or photon source 120, as depicted by the thin, solid lines in FIG. 1. Connecting actuator 150 to vat 105 or photon source 120 allows apparatus 100 to manufacture an article (as discussed below) and/or perform maintenance.

In an alternative embodiment (not shown), the apparatus includes a first actuator and a second actuator. As an example, in this embodiment, the first actuator would connect to the photon source while the second actuator would connect to the gantry or vertical support. In another alternative embodiment, the apparatus includes at least three actuators. As an example, in this embodiment, the first actuator would connect to the photon source, the second actuator connects to the gantry or vertical support, and the third actuator would connect to the vat.

Apparatus 100 further includes a gantry 140 and support rail 145. Gantry 140 provides stability to vertical support 135 while also permitting vertical support 135 to translate horizontally. Support rails 145 stabilize gantry 140 and can facilitate vertical translation. In an alternative embodiment (not shown), the support rails are consolidated.

Apparatus 100 further includes at least one ultrasonic vibrator 155. As shown, ultrasonic vibrator 155 is connected to a surface of vat 105 or a surface of window 115. In another alternative embodiment, the ultrasonic vibrator is integrated into the vat or the window. In additional embodiments, multiple ultrasonic vibrators are utilized. Although not shown, the apparatus may also further include one or more dampers.

In one embodiment (not shown), the ultrasonic vibrator is configured to vibrate between iterative cycles, when the photon source is deactivated. In another embodiment, the ultrasonic vibrator is configured to pulse between iterative cycles. In yet another embodiment, the ultrasonic vibrator pulses during an iterative cycle.

In one embodiment (not shown), the ultrasonic vibrator is configured to operate at a frequency between 15 and 45 kHz. In an alternative embodiment (also not shown), the ultrasonic vibrator is configured to operate at a frequency between 18 and 32 kHz. In another alternative embodiment, the ultrasonic vibrator is replaced with a vibrator configured to operate at a frequency between 700 and 15,000 Hz. As one of ordinary skill in the art will understand, factors such as the vat configuration, the surface finish of the vat, the build material(s) used, the viscosity of the build material(s), the tear strength of the build material(s), the placement and orientation of the vibratory mechanism(s), and selection of continuous or pulsed vibrations will influence the frequency used in the ultrasonic vibrator or vibrator.

Apparatus 100 also includes a control system 160. Control system 160 coordinates operation of apparatus 100 in building an object. A computer is generally used for control system 160, although a variety of equivalent or substitute hardware devices (e.g., without limitation, a tablet, a smartphone, a programmable logic controller (PLC), or a computer numerical control (CNC) machine controller) may be used. In the illustrated embodiment, control system 160 is directly connected to photon source 120, actuator 150, and ultrasonic vibrator 155. In alternative embodiments (not shown), the control system is indirectly or wirelessly connected to components in the apparatus.

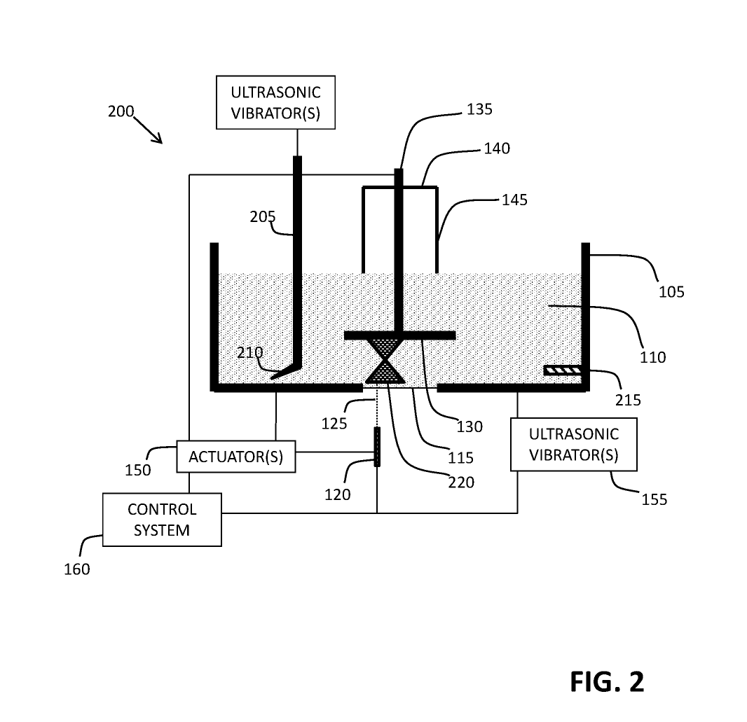

FIG. 2 is a schematic view of an alternative embodiment of an apparatus 200 for 3D printing or additively manufacturing an article incorporating materials having a low tear strength.

As shown in FIG. 2, apparatus 200 is substantially similar to apparatus 100 shown in FIG. 1. In comparison to apparatus 100, apparatus 200 includes an arm 205, an ultrasonic knife 210, and a heating element 215. In addition, FIG. 2 further depicts an object comprising cured build medium 220.

Arm 205 extends into build medium 110 and is configured to agitate, mix, or move matter in vat 105. Arm 205 may agitate, mix, or move matter in vat 105 by translating horizontally, although arm 205 is not limited to horizontal translation. In the illustrated embodiment, arm 205 is disposed primarily vertically. In an alternative embodiment (not shown), the arm is disposed primarily horizontally. In another alternative embodiment, the arm is free to move through three, four, five, or six degrees of freedom. As one of ordinary skill in the art will understand, the arm may be a variety of shapes and dimensions.

Apparatus 200 further includes ultrasonic knife 210. As shown, ultrasonic knife 210 is connected to arm 205. Ultrasonic knife 210 is configured to vibrate ultrasonically and may be used to separate cured build medium from window 115. In particular, ultrasonic knife 210 can be used after an iterative layer is completed. Alternatively, the ultrasonic knife can be used to separate cured build medium from a vat surface. In one embodiment (not shown), the apparatus includes an ultrasonic knife but lacks the ultrasonic vibrator. As one of ordinary skill in the art will understand, the ultrasonic knife may be a variety of shapes and dimensions.

With continued reference to FIG. 2, apparatus 200 further includes heating element 215. Heating element 215 can be used to decrease the viscosity of certain build mediums.

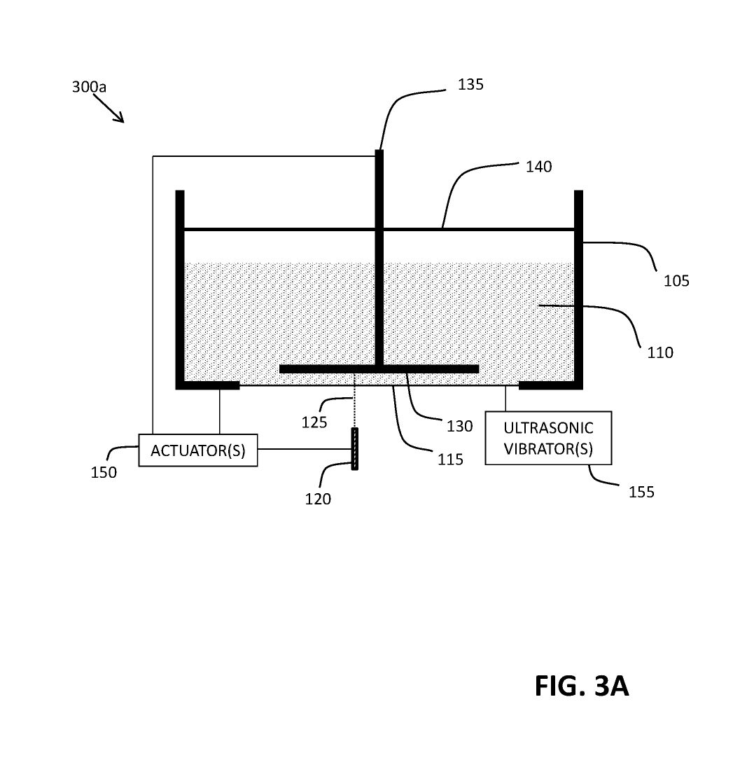

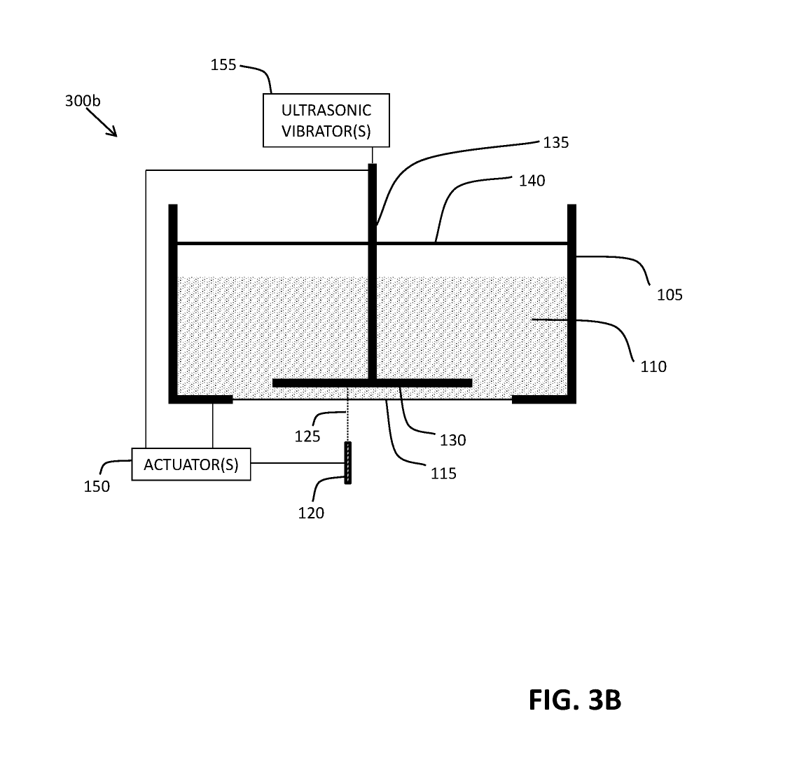

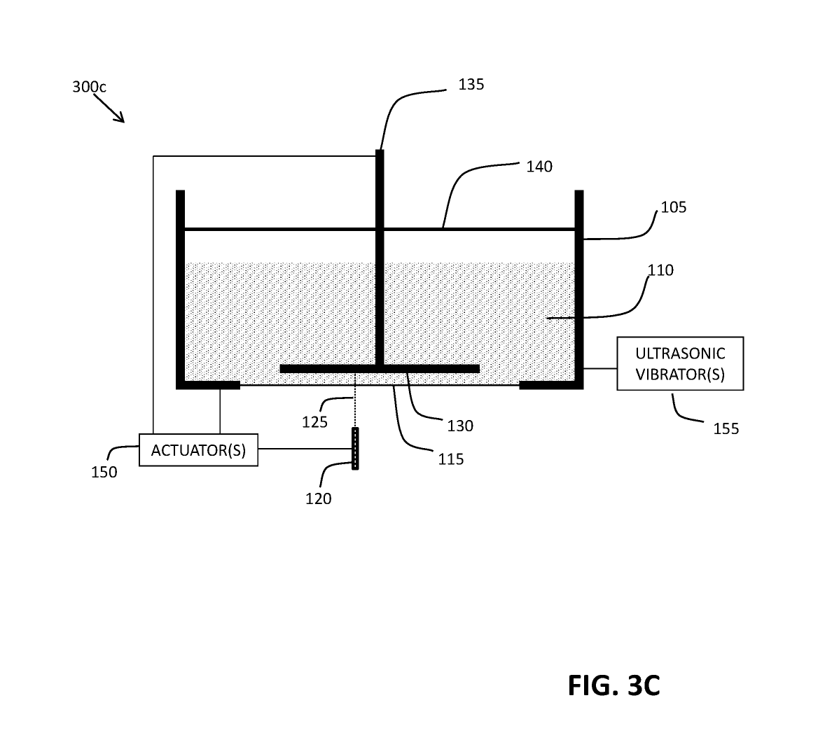

FIG. 3A is a schematic view of an alternative embodiment of an apparatus for 3D printing or additively manufacturing an article incorporating materials having a low tear strength. System 300a is substantially similar to apparatus 100, except for the differences discussed below.

In comparison to apparatus 100 of FIG. 1, system 300a omits support rails 145. In lieu of support rails 145, gantry 140 extends over at least a portion of vat 105.

Likewise, in comparison to apparatus 100 of FIG. 1, system 300a, as provided, omits control system 160. In this embodiment, the control system can be provided separately or as an after-market solution. Companies such as 3D Systems, Carbon 3D, Cura, Simplify 3D, and Stratasys provide exemplary, known control systems and/or software for 3D printing or additive manufacturing. In an alternative embodiment (not shown), the system includes a control system.

FIG. 3B is a schematic view of an alternative embodiment of an apparatus for 3D printing or additively manufacturing an article incorporating materials having a low tear strength. System 300b is substantially similar to apparatuses 100 and 300a, except that in system 300b the ultrasonic vibrator 155 is explicitly shown as being connected to vertical support 135.

FIG. 3C is a schematic view of an alternative embodiment of an apparatus for 3D printing or additively manufacturing an article incorporating materials having a low tear strength. System 300c is substantially similar to apparatuses 100 and 300a except that in system 300c the ultrasonic vibrator 155 is explicitly shown as being horizontally connected to vat 105, thus reinforcing the understanding that system 300c can be vibrated horizontally.

Apparatus 100 further includes a build platform 130, a vertical support 135, and at least one actuator 150. As photons 125 cure build medium 110, the cured build medium (not shown) adheres to build platform 130 and window 115 as an iterative layer. When an iterative layer is completed, actuator 150 raises build platform 130 vertically (via vertical support 135) by a predetermined distance, and the cured build medium is separated from window 115. Viscous build medium 110 then flows into the space vacated by the cured build medium and build platform 130, and the next iterative layer is formed against the prior iterative layer and window 115. In one embodiment (not shown), the photon source is temporarily deactivated when the actuator moves the build plate vertically.

FIG. 3C is a schematic view of an alternative embodiment of an apparatus for 3D printing or additively manufacturing an article incorporating materials having a low tear strength. System 300c is substantially similar to apparatus 100, except for the differences discussed below.

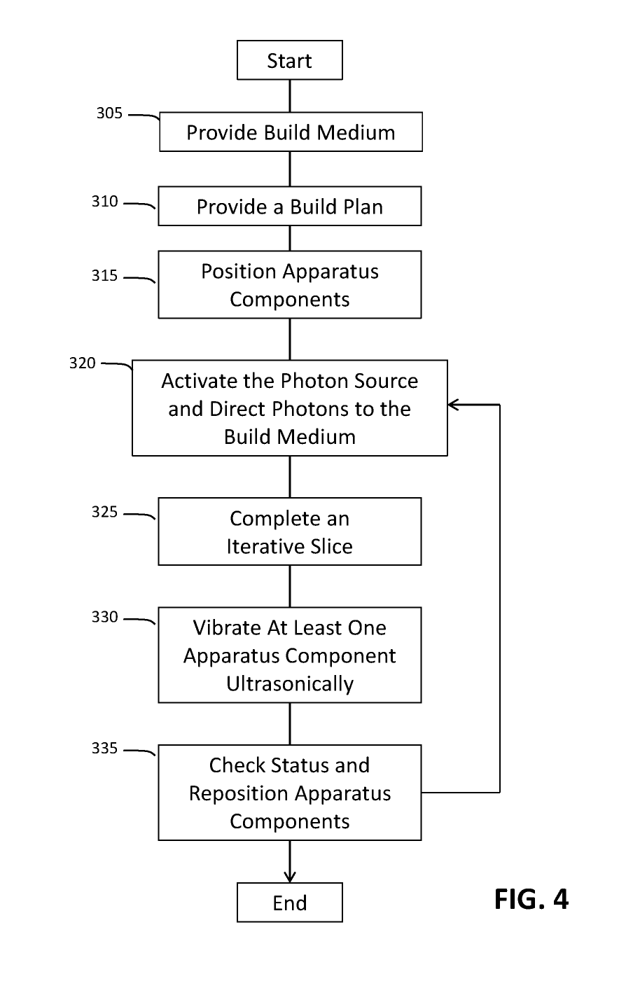

FIG. 4 is a flow chart detailing the steps of a method 300 for additively printing an article incorporating materials having a low tear strength.

Method 300 represents one embodiment of a method performed by an apparatus or system for 3D printing or additively manufacturing an article (e.g., the apparatuses discussed with relation to FIGS. 1-3 above. It is understood that the apparatus or system is controlled by a control system and that power is provided to the apparatus or system (while both an apparatus or system may be used, the following description will use only “apparatus” for simplicity). The power may be alternating current or direct electrical current.

Method 300 then continues with providing step 305, wherein a build medium is provided to the apparatus. As one of ordinary skill in the art will understand, many types of build mediums may be provided to the apparatus. Exemplary build mediums are disclosed in U.S. Provisional Patent Application No. 62/142,271 (entitled, “Actinic Radiation Curable Polymeric Mixtures, Cured Polymeric Mixtures, and Related Processes”), the disclosure of which is incorporated herein. In one embodiment, the build medium is provided continually. In a second embodiment, the build medium is provided in batch increments. In either embodiment, the amount of build medium provided to the apparatus may be monitored with sensors. Additionally, an alert may be generated when the amount of build medium provided to the printing apparatus falls below or exceeds predetermined thresholds.

Method 300 further includes providing step 310, wherein a build plan is provided. The build plan includes a 3D model to be printed by the apparatus. The 3D models may be obtained via 3D scanning, reverse engineering, pre-existing databases, or original designs. The control system is used to coordinate apparatus components when building an object. As one of ordinary skill in the art will understand, the control system can also be used to control various options or settings (e.g., printing resolution).

Method 300 continues with positioning step 315, wherein the apparatus components are positioned prior to a build. Examples include moving the build plate into a starting position and moving the photon source to a starting point.

Method 300 also includes activating and directing step 320, wherein the photon source is activated and photons are directed to the build medium. When the photons reach the build medium, the build medium will cure and adhere to the build platform and the vat window.

In completing step 325, the photon source is moved and additional photons are directed to the build medium. As the photon source is moved, a thin layer that forms an iterative layer of the final object will be completed. As one of ordinary skill in the art will understand, the photon source does not need to be activated continuously as it is moved to complete an iterative layer. The photon source is temporarily deactivated when the iterative layer is completed.

Once an iterative layer is completed, method 300 continues with vibrating step 330. In vibrating step 330, at least one component of the apparatus is vibrated ultrasonically (e.g., at a frequency between 15 and 45 kHz). Exemplary components include, without limitation, the vat, the window, the arm, or an ultrasonic knife. In connection with the vibrating step, the iterative layer is separated from the window. Further, in alternative embodiments (not shown), the vibrating step may be performed in conjunction with peeling cured build medium from the window or shearing cured build medium from the window.

After the iterative layer is separated from the window, method 300 continues with a status check and repositioning step 335. In the status check, the control system checks if additional iterative layers are called for in the build plan. If additional iterative layers are required, the control system directs the photon source to the proper position for commencing the next iterative layer. If additional iterative layers are not required, the control system ends the build cycle.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

1. A system for additive manufacturing, comprising:
at least one photon source configured to direct photons into a build medium;
a vat configured to retain the build medium, wherein the vat includes a window that permits photons to reach the build medium;
a build platform configured to translate vertically;
an actuator configured to cause the build platform to move relative to the vat;
an ultrasonic vibrator connected to the apparatus, wherein the ultrasonic vibrator provides a mechanical force for moving the vat or the build platform; and
a control system that coordinates actions of the vat, build platform, actuator, at least one photon source, and ultrasonic vibrator during production of an article.

2. The additive system of claim 1, wherein the ultrasonic vibrator is configured to operate at a frequency between 15 and 45 kHz

3. The additive system of claim 1, wherein the ultrasonic vibrator is configured to pulse between iterative cycles.

4. The additive system of claim 1, wherein the ultrasonic vibrator is configured to pulse during an iterative cycle.

5. The additive system of claim 1, wherein the ultrasonic vibrator is connected to the vat.

6. The additive system of claim 1, wherein the ultrasonic vibrator is integrated into the vat.

7. The additive system of claim 1, wherein at least one actuator is configured to move the build platform unevenly.

8. The additive system of claim 1, wherein the actuator is configured to move the vat in a horizontal plane.

9. An apparatus for producing three-dimensional objects, comprising:
at least one photon source configured to direct photons into a build medium;
a vat configured to retain the build medium, the vat including a window that permits photons to reach the build medium;
a build platform configured to translate vertically;
an actuator configured to cause the build platform to move relative to the vat; and
a vibrator connected to the apparatus, the vibrator providing a mechanical force for moving the vat or the build platform.

10. The apparatus of claim 9, wherein the vibrator is an ultrasonic vibrator is configured to vibrate vertically.

11. The apparatus of claim 9, wherein the vibrator is an ultrasonic vibrator is configured to vibrate horizontally.

12. The apparatus of claim 9, wherein the apparatus further includes a heating element.

13. The apparatus of claim 9, wherein the apparatus further includes an arm configured to translate horizontally and agitate matter in the vat.

14. The apparatus of claim 13, wherein the arm further includes an ultrasonic knife configured to separate material from a vat surface.

15. A method for producing three-dimensional objects, comprising:
providing power to a printing apparatus;
providing build materials to the printing apparatus;
identifying a structure to be printed by the printing apparatus;
commencing an iterative build process comprising activating and positioning a photon source, directing photons into the build medium across a two-dimensional cross-section, and deactivating the photon source; and
vibrating at least one component of the printing apparatus ultrasonically.

16. The method of claim 15, wherein the build material has less than 250% strain at break and an average maximum stress value in the range of 0.1 to 4 MPa.

17. The method of claim 15, wherein the at least one component of the printing apparatus is vibrated ultrasonically when the photon source is deactivated.

18. The method of claim 15, wherein the at least one component of the printing apparatus is vibrated ultrasonically at pulsing intervals.

19. The method of claim 15, wherein the printing apparatus further includes a build platform and the build platform is moved unevenly between build iterations.

20. The method of claim 15, wherein the process is continuous.
